(19) United States
(12) Patent Application Publication
(10) Pub. No.: US 2023/0217888 A1
(43) Pub. Date: Jul. 13, 2023

(54) LITTER EVACUATION DOOR SYSTEM FOR A LITTER TRAY

(71) Applicant: Jo-Anne Simard, Blainville (CA)

(72) Inventor: Jo-Anne Simard, Blainville (CA)

(21) Appl. No.: 18/087,821

(22) Filed: Dec. 23, 2022

(30) Foreign Application Priority Data
Dec. 23, 2021 (GB) GB2118867.7

(51) Int. Cl. A01K 1/01

(52) U.S. Cl. CPC A01K 1/011

(57) ABSTRACT

A litter evacuation door system includes a door opening defined through a side wall portion of a litter tray, a sliding door guide structure surrounding the door opening, a door slidably engaged in the sliding door guide structure, the door is user selectively movable between a closed and open position, a bag engaging collar extending around an exterior side edge of the door opening and configured for engaging the opening edge of a litter collecting bag, the bag engaging collar further defining a bag collar engaging groove for slidably receiving therein the bag collar plate of a disposable litter collecting bag.

### FIELD OF THE INVENTION

The present invention relates to the general field of litter trays for domestic pet animals and, more particularly, to a litter evacuation door system for a litter tray.

### BACKGROUND OF THE INVENTION

Litter evacuation systems for litter trays are well known on the market and are widely available through pet stores and online shopping web sites.

These known systems typically include a relatively complex mechanical drive assembly that is either automatically operated, manually operated or user selectively operable in either one of these modes. These systems allows to filter or rake litter clumps or agglomerates from the layer of litter absorbing granular material covering the bottom of the litter tray.

These litter evacuation systems further typically include a litter clumps and agglomerates collecting means such as, for example, a removable container, bag or auxiliary compartment, for collecting the evacuated litter from the litter tray. The collecting means needs to be periodically removed by hand from the litter evacuation system so as to be emptied of its content.

While these known litter evacuation systems can generally fulfill the main objective of providing a means for evacuating accumulated litter from the granular absorbing material in a litter tray, they also generally include one or more of the following disadvantages.

Their relatively complex mechanical drive assemblies render these litter trays relatively costly and also subject to break downs after prolonged use, due to the normal wear or jamming of its moving parts.

Furthermore, the main difference between the total number of manual steps required to complete a weekly maintenance of a simple litter tray, compared to the total number of manual steps required to complete the weekly maintenance of a litter tray provided with such a litter evacuation system, essentially resides in that the owner of the latter is not required to manually sift or rake the accumulated litter into the removable container, bag or compartment.

Yet, each week, the owner still has to bend over or knee down close to the litter tray and make a number of manipulation steps by hand for suitably setting or disengage the litter evacuation system from the tray, followed with safely removing the collecting means from the assembly and empty the container, bag or compartment.

Thus, there is a need on the market for an improved litter evacuation system that at least avoids the costly disadvantages of these known systems described above.

In a broad aspect, the present invention provides such an improved litter evacuation systems, and a method of using same.

### SUMMARY OF THE INVENTION

In a broad aspect, the present invention provides a litter evacuation door system for a litter tray.

According to an embodiment of the present invention, the litter evacuation door system comprises a door opening. The door opening extends transversally through a side wall portion of the litter tray.

The door opening upper edge extends substantially proximally parallelly relative to the contour top edge of the litter tray.

The litter evacuation door system further comprises a door. The door lower end has a substantially plate like configuration defined by a door lower end bottom edge, a pair of door lower end side edges, and opposed door lower end inner and outer surfaces.

The door upper end extends substantially upwardly from an upper portion of the door lower end and includes a handle arrangement.

The door lower end is suitably sized and shaped so as to be at least slightly greater than the door opening. And the door upper end is suitably sized and shaped for at least slightly protrude above the litter tray contour top edge when the door lower end is coplanarly in register with the door opening.

The litter evacuation door system further comprises a sliding door guide structure. The sliding door guide structure includes a door engaging slot extending longitudinally horizontally along a longitudinal portion of the contour top edge, and vertically downwardly there through.

The sliding door guide structure further includes a door edge engaging recess extending longitudinally continuously along the pair of door opening side edges and the door opening bottom edge, and further coplanarly and at least partially inwardly relative to these edges.

The door engaging slot is vertically in register above the door engaging slot and extends sufficiently horizontally along the contour top edge, so as to encompass both opposed ends of the door engaging slot proximally the contour top edge of the litter tray.

The door edge engaging recess is suitably shaped and sized for freely slidably engaging in a snug fit relation there in at least a peripheral edge portion of the door lower end bottom edge and the pair of door lower end side edges respectively.

The litter evacuation door system further comprises a bag engaging collar having a substantially elongated configuration extending longitudinally along an outer surface portion of the litter tray side walls and substantially adjacently parallelly relative to at least the door opening bottom edge and the pair of door opening side edges.

The bag engaging collar has a cross-section defining a substantially L-shaped configuration extending at least partially distally outwardly from the litter tray outer side wall surface and at least partially laterally away relative to the door opening, so as to cooperatively form a groove between the bag engaging collar and the litter tray outer side wall surface.

The bag engaging collar is suitably sized and shaped for engaging the opening of a predetermined size and shape of a litter collecting bag such that the contour edge of the bag opening thereof is at least slightly stretched once it is engaged over the bag engaging collar. Thus, a peripheral portion of the bag opening extends laterally and parallelly proximally relative to the litter tray contour top edge.

With the door lower end vertically and downwardly slidably engaged through the door engaging slot of the sliding door guide structure, and using its handle arrangement, the door is manually movable between a door closed position, wherein the door lower end has its peripheral edge portion engaged in the door edge engaging recess, and a door open position, wherein the door is sufficiently raised vertically such the door lower end bottom edge is substantially adjacent under the litter tray contour top edge.

In some embodiments of the present invention, the litter evacuation door system further comprises a bag collar engaging groove.

In some other embodiments of the present invention, the litter evacuation door system further comprises a disposable litter collecting bag slidably engeable in the bag collar engaging groove.

Other advantages, novel features and alternate embodiments of the present invention will be more apparent from the following drawings and detailed description.

### BRIEF DESCRIPTION OF THE DRAWINGS

FIG. 1, in a perspective view, illustrates an embodiment of a litter tray including a litter evacuation door system, according to the present invention, here shown with a sliding door of the system in a closed position;

FIG. 2, illustrates the litter tray in FIG. 1, here shown with the sliding door of the system in an open position;

FIG. 3, in a first end elevational view, illustrates the litter tray in FIG. 1, here shown with the sliding door of the system in the closed position;

FIG. 4, illustrates the litter tray in a same view as in FIG. 3, here shown with the sliding door of the system in the open position;

FIG. 5, in a side elevational view, illustrates the litter tray in FIG. 1, here shown with the sliding door of the system in the closed position, an opposite side elevational view of the litter tray being a mirror image of FIG. 5;

FIG. 6, illustrates the litter tray in a same view as in FIG. 5, here shown with the sliding door of the system in the open position;

FIG. 7, in a top plan view, illustrates the litter tray in FIG. 1, here shown having a sliding door removed from a door engaging slot;

FIG. 8, in a bottom plan view, illustrates the litter tray in FIG. 1;

FIG. 9, in a perspective view, illustrates the litter tray in FIG. 1, here shown with the sliding door of the system in the closed position and provided with a litter collecting bag having its opening engaged on a bag engaging collar of the system;

FIG. 10, illustrates the litter tray in FIG. 9, here shown with the sliding door of the system in the open position and the litter collecting bag partially filled with litter; and

FIG. 11, in a plan view, illustrates a sliding door;

FIG. 12, in a perspective view, illustrates another embodiment of a litter tray including a litter evacuation door system, according to the present invention, here shown with a sliding door of the system in a closed position;

FIG. 13, in a perspective view, illustrates the litter tray including the litter evacuation door system in FIG. 12, here shown from another perspective angle;

FIG. 14, in a perspective view, illustrates the litter tray including the litter evacuation door system in FIG. 12, here shown with the door open and a disposable litter collecting bag releasably engaged with the litter evacuation door system;

FIG. 15, in perspective view, illustrates the litter tray including the litter evacuation door system in FIG. 12, here shown from another perspective angle that is similar to the one in FIG. 13;

FIG. 16, in a perspective exploded view, illustrates the litter tray including the litter evacuation door system in FIG. 12;

FIGS. 17 and 18, in a door similar to the one in FIG. 11;

FIGS. 19 and 20, in a side and front end views, illustrates a disposable litter collecting bag;

FIGS. 21 to 25, in various views, illustrates a U-shaped back plate;

FIG. 26, in a partial perspective exploded view, illustrates a back plate aligned for engagement with an inner side surface of the litter tray;

FIG. 27, in a perspective exploded view, illustrates the back plate and litter tray in FIG. 26, here shown from the outer side.

### DETAILED DESCRIPTION OF THE INVENTION

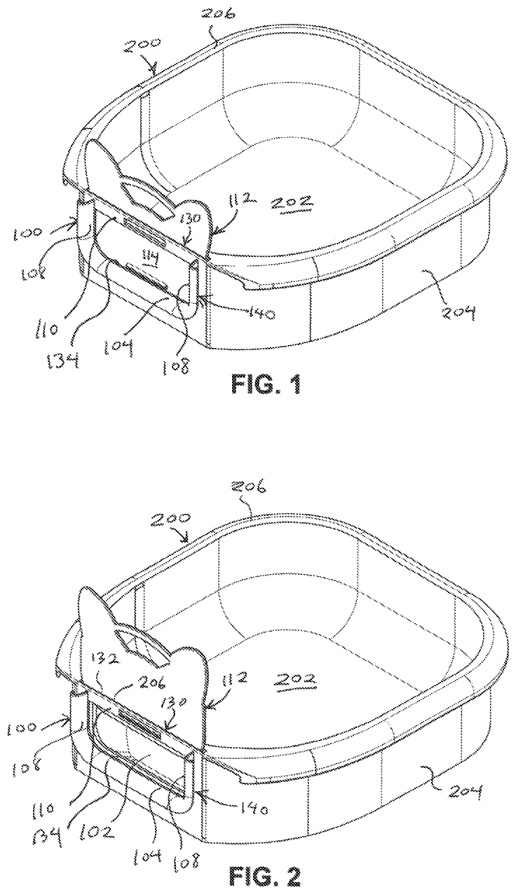

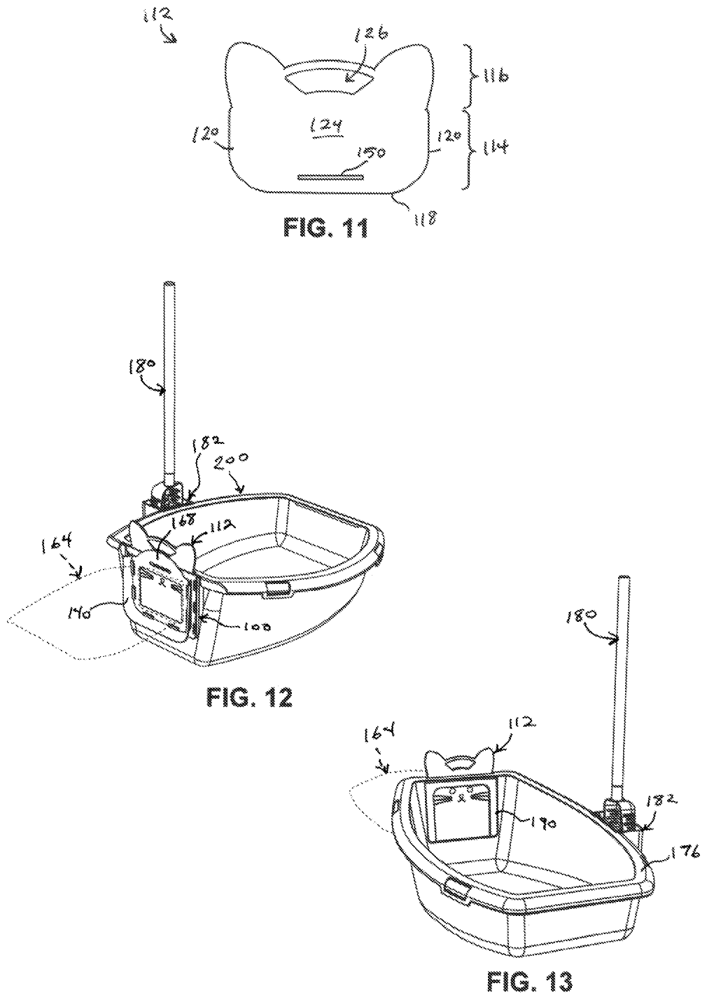

FIGS. 1 to 11 inclusively, illustrate various aspects of an embodiment, according to the present invention, of a litter evacuation door system 100 for a litter tray 200.

The litter tray 200 includes a bottom wall 202, side walls 204 and a contour top edge 206.

The litter evacuation door system 100 comprises a door opening 102, as best illustrated in FIGS. 2, 4 and 6. The door opening 102 extends transversally through a side wall portion of the litter tray 200, and defines a door opening bottom edge 106, a pair of door opening side edges 108 and a door opening upper edge 110.

The door opening upper edge 110 extends substantially proximally parallelly relative to the contour top edge 206 of the litter tray 200.

Referring, for example, to FIGS. 1, 2, 6 and 11, the litter evacuation door system 100 further comprises a door 112. The door 112 includes a door lower end 114 and a door upper end 116.

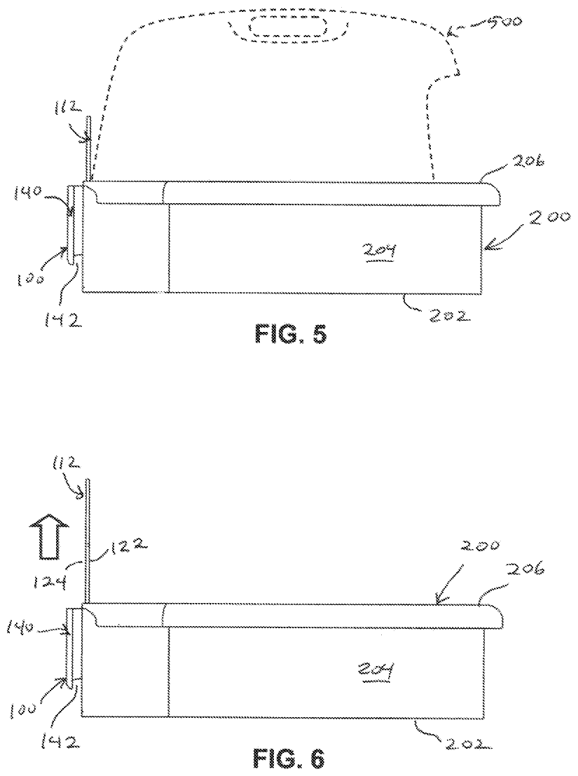

The door lower end 114 has a substantially plate like configuration defined by a door lower end bottom edge 118, a pair of door lower end side edges 120, and opposed door lower end inner and outer surfaces 122 and 124 respectively, as best illustrated in FIG. 6.

The door upper end 116 extends substantially upwardly from an upper portion of the door lower end 114 and includes a handle arrangement 126.

The door lower end 114 is suitably sized and shaped so as to be at least slightly greater than the door opening 102. And the door upper end 116 is suitably sized and shaped for at least slightly protrude above the litter tray contour top edge 206 when the door lower end 114 is coplanarly in register with the door opening 102.

The litter evacuation door system 100 further comprises a sliding door guide structure 130. Referring now more particularly to FIGS. 1, 2 and 7, the sliding door guide structure 130 includes a door engaging slot 132 extending longitudinally horizontally along a longitudinal portion of the contour top edge 206, and vertically downwardly there through.

The sliding door guide structure 130 further includes a door edge engaging recess 134 extending longitudinally continuously along the pair of door opening side edges 108 and the door opening bottom edge 106, and further coplanarly and at least partially inwardly relative to these edges 108 and 106 respectively.

The door engaging slot 132 is vertically in register above the door engaging slot 132 and extends sufficiently horizontally along the contour top edge 206, so as to encompass both opposed ends of the door engaging slot 132 proximally the contour top edge 206 of the litter tray 200.

The door edge engaging recess 134 is suitably shaped and sized for freely slidably engaging in a snug fit relation there in at least a peripheral edge portion of the door lower end bottom edge 118 and the pair of door lower end side edges 120 respectively.

The litter evacuation door system 100 further comprises a bag engaging collar 140. The bag engaging collar 140 has a substantially elongated configuration extending longitudinally along an outer surface portion of the litter tray side walls 204 and substantially adjacently parallelly relative to at least the door opening bottom edge 106 and the pair of door opening side edges 108.

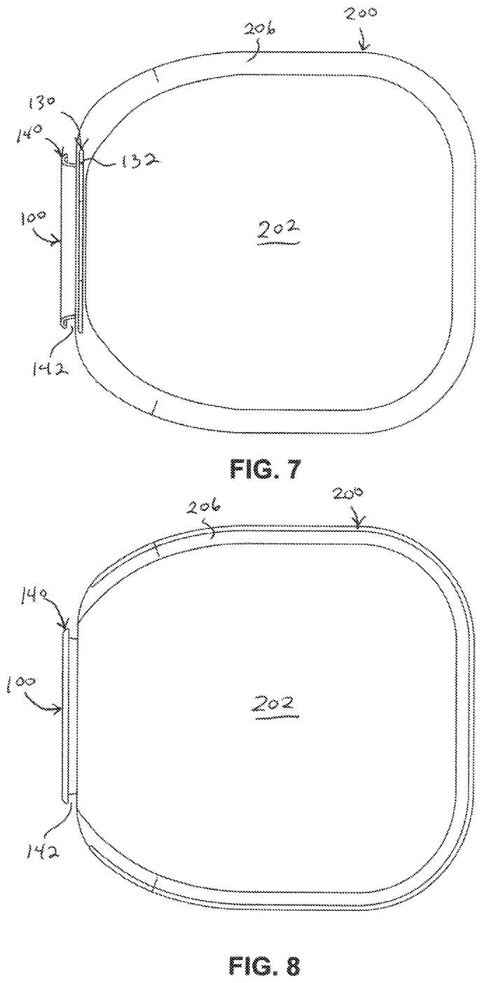

As best illustrated in FIGS. 5 to 8 inclusively, the bag engaging collar 140 has a cross-section defining a substantially L-shaped configuration extending at least partially distally outwardly from the litter tray outer side wall surface and at least partially laterally away relative to the door opening 102, so as to cooperatively form a groove 142 between the bag engaging collar 140 and the litter tray outer side wall surface, as best illustrated in FIGS. 6 and 7.

Referring to FIGS. 7 and 8, the bag engaging collar 140 is suitably sized and shaped for engaging the opening 302 of a predetermined size and shape of a litter collecting bag 300 such that the contour edge of the bag opening 301 thereof is at least slightly stretched once it is engaged over the bag engaging collar 140. Thus, a peripheral portion of the bag opening 302 extends laterally and parallelly proximally relative to the litter tray contour top edge 206.

Obviously, a removable string having a suitable length or an elastic rubber band (not shown in the figures) may be used to further secure the bag opening 302 around the bag engaging collar 140.

With the door lower end 114 vertically and downwardly slidably engaged through the door engaging slot 132 of the sliding door guide structure 130, and using its handle arrangement 126, the door 112 is manually movable between a door closed position, wherein the door lower end 114 has its peripheral edge portion engaged in the door edge engaging recess 134 as illustrated in FIG. 1, and a door open position, wherein the door 112 is sufficiently raised vertically such the door lower end bottom edge is substantially adjacent under the litter tray contour top edge 206, as illustrated in FIG. 2.

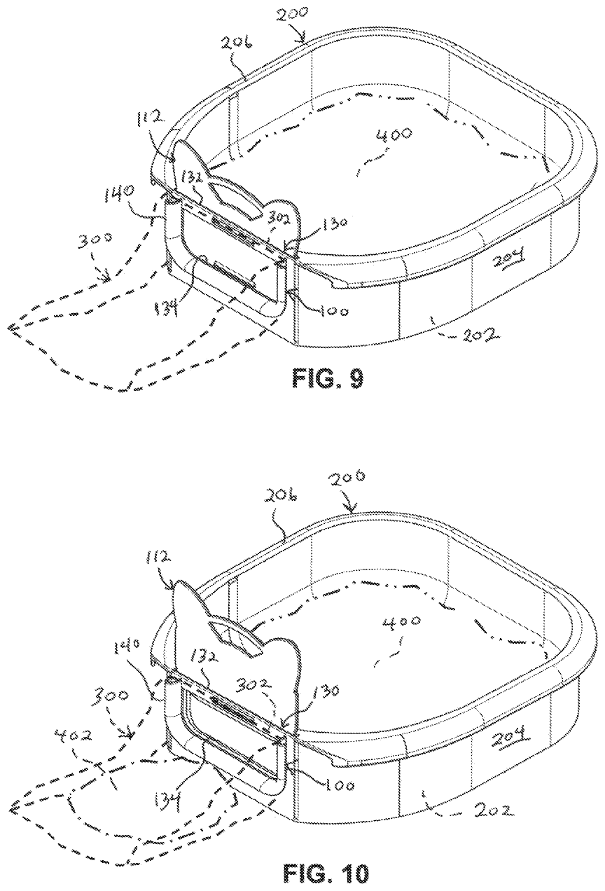

Thus, as illustrate in FIG. 9, with the door 112 in the door closed position, a litter collecting bag 300 engaged on the bag engaging collar 140, and litter absorbing material 400 covering the litter tray bottom wall 202, the litter tray 200 may be used by a domestic pet animal in a normal fashion.

And periodically, the user may selectively move the door 112 in the door open position, as illustrated in FIG. 10, so as to be able to direct agglomerated litter material 402 into the litter collecting bag 300 using a suitable hand implement designed for this purpose such as a litter sifter scoop, hand rake or the like (not illustrated).

Hence, the periodic maintenance of the litter tray 200 thus equipped with the litter evacuation door system 100 is less cumbersome to use than the conventional fashion of using a hand bucket or equivalent to remove the agglomerated litter material from a conventional litter tray.

Furthermore, the litter tray 200 thus equipped with the litter evacuation door system 100 is less expensive to buy, is not prone to costly break downs, and its maintenance does not require a significantly greater number of hand manipulations compared to automated or semi-automated litter evacuation systems of the prior art.

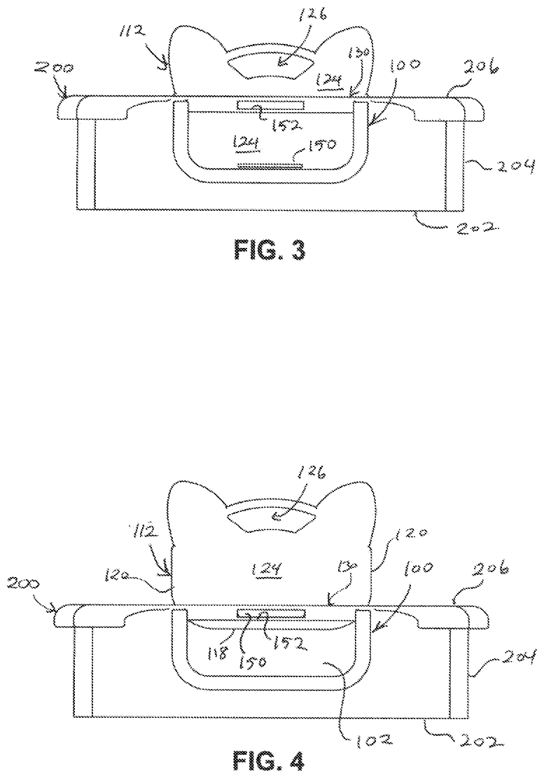

In some embodiments of the invention, as best illustrated in FIGS. 3, 4 and 11, the door upper end 116 may be adorned with indicia's, cut outs and/or three dimensional forms for suggesting the type of domestic pet animal for which the litter tray 200, thus equipped with the litter evacuation door system 100, is intended.

Referring more particularly to FIGS. 3, 4 and 11, in some embodiments of the invention the litter evacuation door system 100 further comprises a releasable lock arrangement for user selectively and releasably maintaining the door 112 in the door open position.

The releasable lock arrangement 150 includes a door surface protuberance 150 located adjacently a lower edge portion 118 of the door lower end outer surface 124, and a door locking cavity or aperture 152 extending inwardly relative to an interior surface portion of the door engaging slot 132 that is substantially vertically in register with the door surface protuberance 150.

The door surface protuberance 150 and the door locking cavity 152 are compatibly sized and shaped such that, when the door 112 is moved from the door closed position to the door open position, and back to the door closed position, the door surface protuberance 150 engages and disengages, respectively, the door locking cavity 152 without requiring significant effort from the user operating the door 112.

Furthermore, when the door surface protuberance 150 is engaged in the door locking cavity 152, the engagement there between is sufficient to maintain the door 112 in the door open position.

In some embodiments of the invention, the bag engaging collar 140 may completely surround the door opening 102.

As is common with conventional litter trays of the prior art, the litter tray 200 provided with the litter evacuation door system 100 may be equipped with a removable litter tray cover 500, so as to form a litter box.

As illustrated in FIG. 5, the bottom edge portion of the litter tray cover 500 may be suitably sized and shaped for extending along a litter tray contour top edge 206 extending parallelly proximally along an inner side of the door engaging slot 132, or encompassing the door 112 so as to extend along the opposite outer side of the door engaging slot 132.

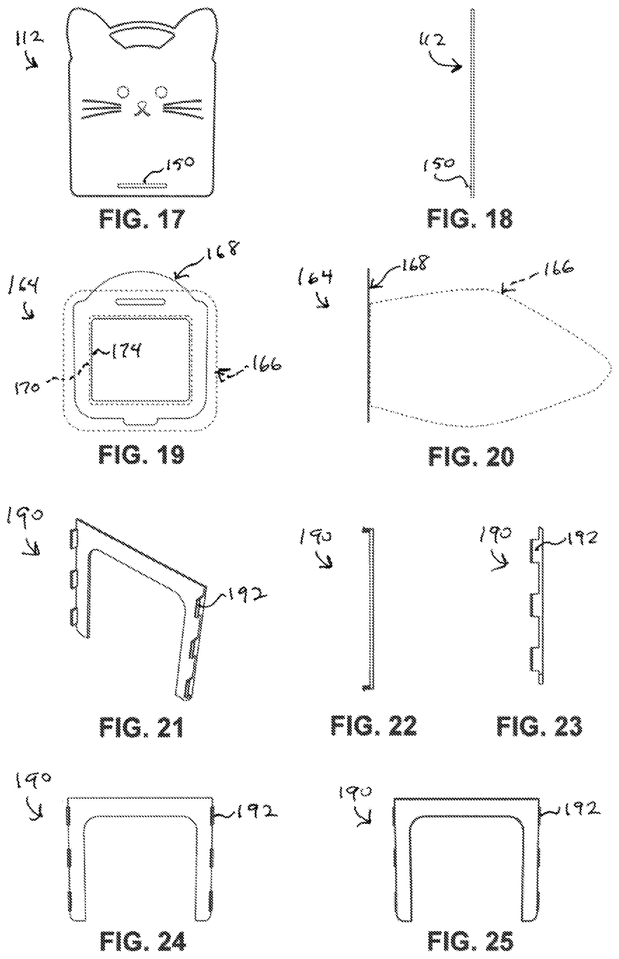

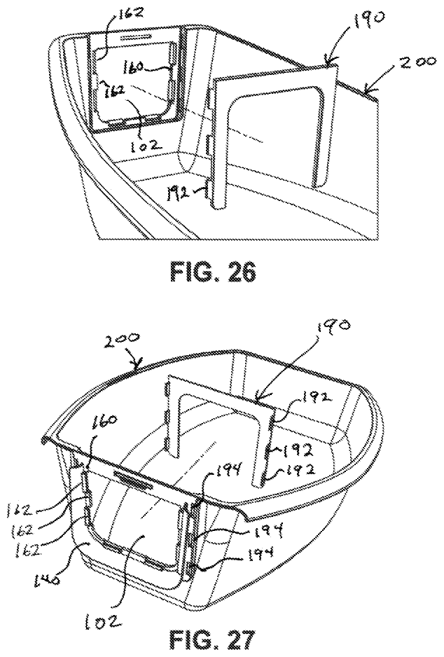

Referring to FIGS. 12 to 27 inclusively, in some embodiments of the invention, the litter evacuation door system 100 further comprises a bag collar engaging groove 160.

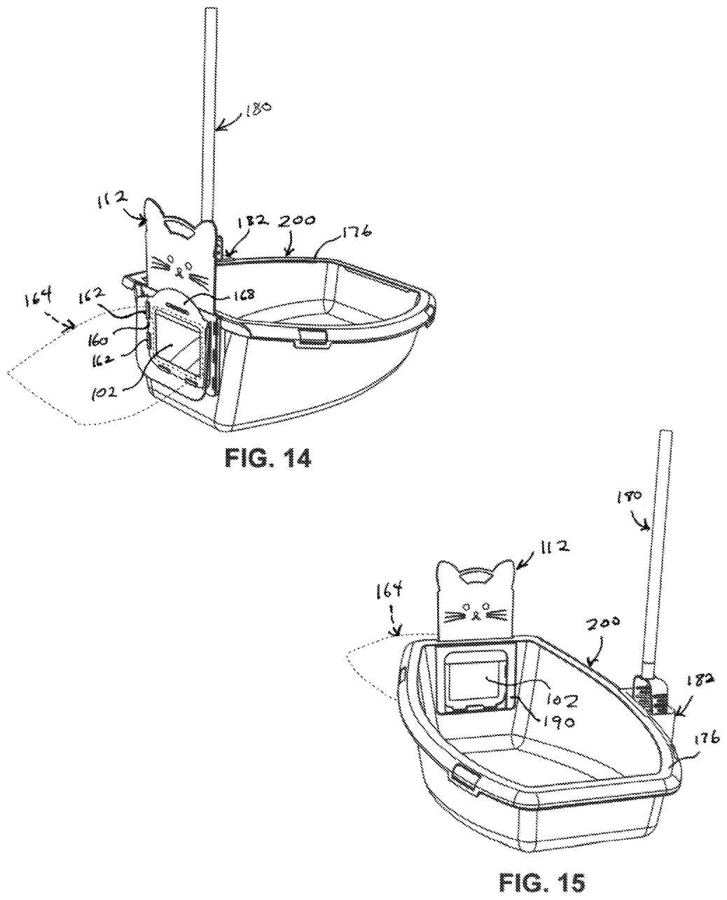

Referring now more particularly to FIGS. 14, 16, and 27, the bag collar engaging groove 160 extends at least partially inwardly relative to an inner surface portion of the bag engaging collar 140 that is located substantially proximally parallelly relative to the pair of door opening side edges 108 and the door opening bottom edge 106, so as to define substantially U-shaped configuration there along.

Furthermore, the bag collar engaging groove 160 defines opposed open groove ends extending substantially upwardly distally relative to the litter tray 200.

Furthermore, the thus upwardly open ended U-shaped bag collar engaging groove 160 is suitably sized and shaped for freely slidably receiving therein in a downward movement, and in a snug-fit relation, a relatively thin plate-like element.

As best illustrated in FIG. 27, the bag collar engaging groove 160 may be formed via a double series of suitably shaped and located tabs 162 distributed in a spaced apart relationship along the inner surface portion of the bag engaging collar 140.

Referring more particularly to FIGS. 19, 20 and 27, in some embodiments of the invention, the litter evacuation door system 100 further comprises a disposable litter collecting bag 164. The disposable litter collecting bag 164 includes a bag component 166 and a bag collar plate 168.

The bag component 166 defines a bag component opening edge 170 and the bag collar plate 168 has a substantially plate-like configuration defining a bag collar plate contour 172 and a bag collar plate opening 174 extending substantially centrally through the bag collar plate 168.

Furthermore, a contour edge of the bag collar plate opening 174 is sealably connected to the bag component opening edge 170.

The bag collar plate 168 is suitably sized and shaped for user selectively and slidably engaging in a downward movement the bag collar engaging groove 160. Furthermore, the bag collar plate opening 174 and bag component opening edge 170 are cooperatively sized and shaped so as to extends substantially the whole door opening 102, as best illustrated in FIG. 14.

Advantageously, the disposable litter collecting bag 164 has both its bag component 166 and bag collar plate 168 made of biodegradable material, or materials, so as to allow the disposable litter collecting bag 164 containing litter material 402 to be disposed of in an organic waste cart or container. For example, the bag component 166 may be made of recycled paper, and the bag collar plate 168 made of recycled and light weight corrugated cardboard.

Further advantageously, the litter evacuation door system 100 of the present invention is rendered concurently compatible to both a conventionsal litter collecting bag 300 having a flexible opening edge, and a disposable litter collecting bag 164 as described above.

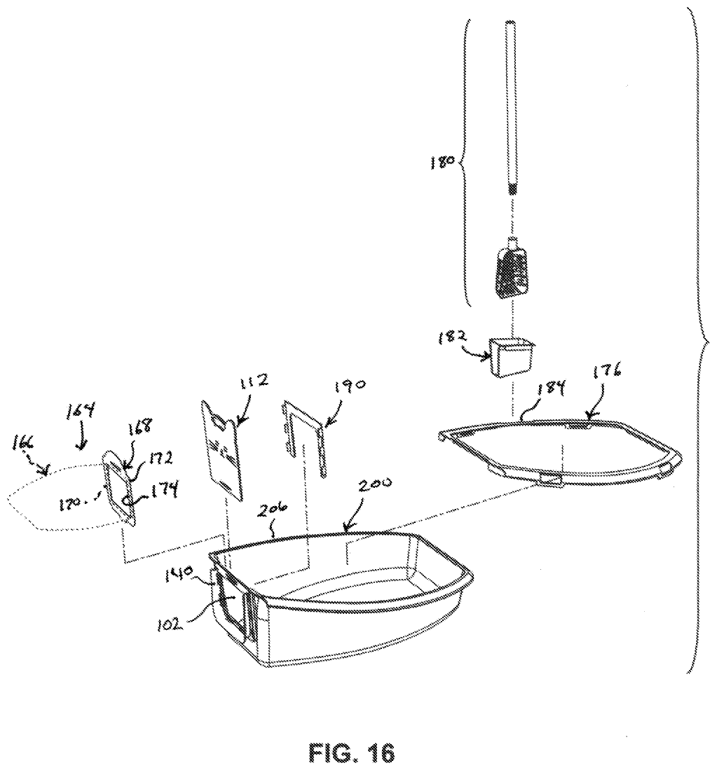

As best exemplified in FIGS. 15 and 16, the litter tray 200 may be provided with a litter contour edge cover 176 suitably sized and configured for engaging in a snap-fit relation the litter tray contour top edge 206.

The litter contour edge cover 176 may be used to secure the opening edge of a litter bag, such as a litter sifting liner (not shown in the figures) along the litter contour top edge 206, with a portion of the litter bag opening lowered along the door opening bottom edge 106.

The litter tray 200 may further be conveniently provided with a cat litter scoop 180 and holder 182 combination engaged along a top edge portion of the litter tray 200.

As can be inferred from in FIGS. 15 and 16, the scoop holder 182 may have a hook shaped top edge portion suitably sized and shaped for releasably engaging in a snap-fit relation a compatibly shaped recess 184 along an edge portion of the litter contour edge cover 176.

Furthermore, the cat litter scoop 180 is preferably represented by a collapsible two-part litter scoop. Thus, both the releasable scoop holder 182 and two-part cat litter scoop 180 may be conveniently stowed within the litter tray 200 for an economy of storage space and shipping costs.

It is also demonstrated through FIGS. 16 and 21 to 27 that the door 112 of the litter evacuation door system 100 may be slidably engaged to the litter tray 112 through an inverted U-shaped back plate 190 provided with back plate engaging tabs 192 engageable in compatibly shaped tab receiving openings 194, that are suitably shaped and located along edge portions of the door opening 102.

Although the present invention has been described hereinabove by way of preferred embodiments thereof, it can be modified, without departing from the spirit and nature of the subject invention.

What is claimed is:

1. A litter evacuation door system for a litter tray, the litter tray including a bottom wall, side walls and a contour top edge, the litter evacuation door system comprising:
a door opening, the door opening
extending transversally through a side wall portion of the litter tray, and
defining a door opening bottom edge, a pair of door opening side edges and a door opening upper edge,
wherein the door opening upper edge extends substantially proximally parallelly relative to the contour top edge;
a door, the door
including a door lower end and a door upper end,
the door lower end having a substantially plate like configuration defined by a door lower end bottom edge, a pair of door lower end side edges, and opposed door lower end inner and outer surfaces and,
the door upper end extends substantially upwardly from an upper portion of the door lower end and includes a handle arrangement,
wherein the door lower end being suitably sized and shaped so as to be at least slightly greater than the door opening, and the door upper end being suitably sized and shaped for at least slightly protrude above the litter tray contour upper edge when the door lower end is coplanarly in register with the door opening;
a sliding door guide structure, the sliding door guide structure including
a door engaging slot extending longitudinally horizontally along a longitudinal portion of the contour top edge, and vertically downwardly there through, and
a door edge engaging recess extending longitudinally continuously along the pair of door opening side edges and the door opening bottom edge, and coplanarly and at least partially inwardly relative to these edges and,
wherein the door engaging slot being vertically in register above the door engaging slot and extending sufficiently horizontally along the contour top edge so as to encompass both opposed ends of the door engaging slot proximally the contour top edge of the litter tray,
wherein the door edge engaging recess is suitably shaped and sized for freely slidably engaging in a snug fit relation at least a peripheral edge portion of the door lower end bottom edge and the pair of door lower end side edges respectively;
a bag engaging collar, the bag engaging collar
having a substantially elongated configuration extending longitudinally along an outer surface portion of the litter tray side walls and substantially adjacently parallelly relative to at least the door opening bottom edge and the pair of door opening side edges,
the bag engaging collar having cross-section defining a substantially L-shaped configuration extending at least partially distally outwardly from the litter tray outer side wall surface and at least partially laterally away relative to the door opening, so as to cooperatively form a groove between the bag engaging collar and the litter tray outer side wall surface,
wherein the bag engaging collar is suitably sized and shaped for engaging the opening of a predetermined size and shape of a litter collecting bag such that the contour edge of the bag opening is at least slightly stretched once it is engaged over the bag engaging collar, with a peripheral portion of the bag opening extending laterally and parallelly proximally relative to the litter tray contour upper edge;
wherein, with the door lower end vertically and downwardly slidably engaged through the door slot of the sliding door guide structure, the door is manually movable using its handle arrangement between a door closed position, wherein the door lower end has its peripheral edge portion engaged in the door edge engaging recess, and a door open position, wherein the door is sufficiently raised vertically such the door lower end bottom edge is substantially adjacent under the litter tray contour upper edge;
whereby, with the door in the door closed position, a litter collecting bag engaged on the bag engaging collar, and litter absorbing material covering the litter tray bottom wall, the litter tray may be used by the domestic pet animal in a normal fashion, and, periodically, the user may momentarily move the door in the door open position so as to be able to direct agglomerated litter material into the litter collecting bag using a suitable hand implement designed for this purpose.

2. The litter evacuation door system in claim 1 further comprises a bag collar engaging groove, the bag collar engaging groove
extends at least partially inwardly relative to an inner surface portion of the bag engaging collar that is located substantially proximally parallelly relative to the pair of door opening side edges and the door opening bottom edge, so as to define substantially U-shaped configuration there along, and
the bag collar engaging groove further defines opposed open groove ends extending substantially upwardly distally relative to the litter tray,
wherein the thus upwardly open ended U-shaped bag collar engaging groove is suitably sized and shaped for freely slidably receiving therein in a downward movement, and in a snug-fit relation, a relatively thin plate-like element;

3. The litter evacuation door system in claim 2 further comprises comprises a disposable litter collecting bag, the disposable litter collecting bag includes
a bag component and a bag collar plate, and
the bag component defines a bag component opening edge and the bag collar plate has a substantially plate-like configuration defining a bag collar plate contour and a bag collar plate opening extending substantially centrally through the bag collar plate,
wherein a contour edge of the bag collar plate opening is sealably connected to the bag component opening edge,
wherein the bag collar plate is suitably sized and shaped for user selectively and slidably engaging in a downward movement the bag collar engaging groove, and
wherein the bag collar plate opening and bag component opening edge are cooperatively sized and shaped so as to extends substantially the whole door opening;

4. The litter evacuation door system in claim 1 wherein the bag engaging collar completely surrounds the door opening.
